(19) United States
(12) Patent Application Publication
(10) Pub. No.: US 2026/0299149 A1
(43) Pub. Date: Oct. 1, 2026

(54) NEUTRON DOSIMETRY

(71) Applicant: Thermo Fisher Scientific Messtechnik GmbH, Erlangen (DE)

(72) Inventors: Julius Scherzinger, Fürth, Bavaria (DE); Erich Leder, Heroldsbach, Bavaria (DE); Reinhard Buchhold, Erlangen, Bavaria (DE); Christian Riegel, Erlangen, Bavaria (DE)

(73) Assignee: Thermo Fisher Scientific Messtechnik GmbH, Erlangen (DE)

(21) Appl. No.: 19/635,046

(22) Filed: Mar. 31, 2026

Related U.S. Application Data
(60) Provisional application No. 63/781,111, filed on Mar. 31, 2025.

(51) Int. Cl. G01T 7/00; G01T 3/00

(52) U.S. Cl. CPC G01T 7/005; G01T 3/001

(57) ABSTRACT

There is provided a method for determining a rate of radiation. The method comprises determining information from a first set of neutrons, wherein the first set of neutrons are analysed at a first neutron detector. The method also comprises calibrating, based on the information from the first set of neutrons, a neutron signal spectrum of a second set of neutrons, wherein the second set of neutrons are analysed at a second neutron detector.

### CROSS REFERENCE TO RELATED APPLICATION

This application claims the benefit of U.S. Provisional Patent Application No. 63/781,111, filed Mar. 31, 2025, which is hereby incorporated by reference in its entirety.

### FIELD

The present invention relates to determining a rate and an amount of radiation. In particular, determining a rate and an amount of neutron radiation.

### BACKGROUND

Personal dosimetry is a technique well used for determining a rate of radiation. Here, dosimeters may be used to determine a rate and an amount of radiation from different types of radiation, examples of which are gamma radiation, beta radiation and neutron radiation.

A first type of known dosimeters measures real-time radiation, where such dosimeters are called active or electronic dosimeters, for example Electronic Personal Dosimeters (EPDs). Active dosimeters provide immediate and continuous measurement of radiation. Active dosimeters may measure the amount of radiation within a short time period, e.g. per second, and determine whether the measured radiation exceeds a threshold. Such dosimeters provide a fast measurement and alarm to a user when a threshold has been reached. Therefore, the wearer of the device may be alerted to indicate that they must leave the radiation field. However, the measurement may not be exact.

A second type of known dosimeters measure radiation over a set period of time, for example over a month or a quarter. Such dosimeters may be referred to as passive dosimeters. An example of a passive dosimeter is a TLD (Thermoluminescent dosimeter) card. A TLD card absorbs radiation energy, where such energy is stored in the card. At the end of the set period of time, the card is heated to a high temperature, and the energy is emitted as light. The amount of light which is released may be measured and is proportional to the radiation dose. Passive dosimeters therefore may provide an accurate and precise measurement of radiation over the set period of time. However it is not possible to measure a real time radiation using passive dosimeters.

### SUMMARY

In a first aspect, there is provided a method for determining a rate of radiation. Preferred or advantageous features are set out in the dependent claims and description.

There is provided a method for determining a rate of radiation comprising determining information from a first set of neutrons. The first set of neutrons are analysed at a first neutron detector. A neutron signal of the second set of neutrons is calibrated based on the information from the first set of neutrons. The second set of neutrons are analysed at a second neutron detector.

In some examples the method may further comprise determining one or more calibration factors, based on the information from the first set of neutrons, wherein the calibrating step is performed using the one or more calibration factors.

In some examples, the first set of neutrons may be a set of fast neutrons, and the second set of neutrons is a set of thermal neutrons, and wherein the information is determined from a fast neutron signal spectrum.

In some examples, the one or more calibration factors may comprise a fast neutron calibration factor, and a thermal neutron calibration factor. The fast neutron signal spectrum is calibrated using the fast neutron calibration factor, and the thermal neutron signal spectrum is calibrated using the thermal neutron calibration factor.

In some examples, the thermal neutron calibration factor may be an energy dependent calibration factor. In other words, the thermal neutron calibration factor may be selected based on energy. In some examples, the thermal neutron calibration factor may be selected based on the energy of the fast neutron spectrum.

In some examples, the calibrated fast neutron signal spectrum and calibrated thermal neutron signal spectrum may be combined, to provide a calibrated energy response curve.

In some examples, the method may comprise determining a range of energy channels using the information, wherein the calibrated energy response curve is calculated for the range of energy channels.

In some examples, the range of energy channels may have a lower threshold and upper threshold, wherein the lower and upper thresholds are determined to reduce non-neutron radiation, and to limit the overresponse for high neutron energies.

In some examples, the combining of the fast and thermal neutron signal spectrum may be based on an energy dependent algorithm, wherein the algorithm includes the one or more calibration factors.

In some examples, the algorithm may be configured such that the calibrated energy response is within a predetermined upper limit and lower limit for the range of energy channels.

In some examples, the calibrated energy response may be calculated using

$$Hp 10 N = \text{?} \cdot {\sum }_{i = {L}_{TN}}^{{H}_{TN}} {TN}_{i} + {CF}_{FN} \cdot {\sum }_{i = {L}_{FN}}^{{H}_{FN}} {FN}_{i} ,$$

wherein Hp10N is the energy response, [symbol] is the thermal neutron calibration factor, CF_{FN} is the fast neutron calibration factor, TNᵢ is the i^{th} channel of a thermal neutron multichannel analyser, FNᵢ is the i^{th} channel of a fast neutron multichannel analyser, H_{TN} and H_{FN} is high threshold of the thermal neutron channel and fast neutron channel respectively; L_{TN} and L_{FN} is low threshold of the thermal neutron channel and fast neutron channel respectively.

In some examples, the calibration step may be performed periodically over a time duration. In some examples, the calibration factors may be calculated periodically.

In some examples measuring the thermal neutron energy response may comprise integrating over the range of energy channels.

In some examples, the method may be performed over a time duration to provide a long-term radiation dose measurement.

In some examples, the method may further comprise determining an instantaneous radiation dose measurement, using information received from the first and second neutron detectors.

In another aspect, there is provided a device comprising a first detector configured to detect a first set of neutrons, a second detector configured to detect a second set of neutrons, wherein the first and second detectors are configured to be in communication with a processor, wherein the processor is configured to perform any of the methods described herein.

In another aspect, there is provided a system comprising a dosimeter, one or more Multichannel Analyzers (MCA(s)), a memory, and a processor. The dosimeter may comprise two separate detectors for detecting thermal neutrons and fast neutrons. The memory may be configured to store calibration data and may be configured to store instructions for performing the methods described herein. The processor may be configured to perform the methods described herein. The MCA may be configured to receive a signal from one or more of the thermal and/or fast neutron detectors to analyse the signals. There may be a MCA for each of the radiation detectors. The one or more MCA(s) may be configured to transmit data to the processor.

In another aspect, there may be provided a computer-readable storage medium comprising instructions which, when executed on a computer, cause the computer to carry out the steps of any method described herein.

### BRIEF DESCRIPTION OF DRAWINGS

Various aspects of at least one embodiment are discussed below with reference to the accompanying figures, which are not intended to be drawn to scale. The figures are included to provide illustration and a further understanding of the various aspects and embodiments, and are incorporated in and constitute a part of this specification, but are not intended as a definition of the limits of the invention. In the figures, each identical or nearly identical component that is illustrated in various figures is represented by a like numeral. For purposes of clarity, not every component may be labelled in every figure.

FIG. 1 shows a graph of dose response of electronic personal dosimeters;

FIGS. 2A and 2B show an energy spectrum of mono energetic neutrons, and an energy spectrum of polychromatic neutron sources, respectively;

FIG. 3 shows a graph of neutron response according to examples described herein;

FIG. 4 shows a graph of neutron response according to examples described herein; and

FIG. 5 shows a graph including a geometric cut, according to examples described herein.

FIG. 6 shows a set of perspective views of an exemplary dosimeter or radiation dose meter (RDM);

FIG. 7 shows a schematic diagram of a layout of components within the RDM of FIG. 6;

FIG. 8 shows a top plan view of radiation detectors within the RDM of FIG. 6.

The invention will now be described in relation to specific embodiments. The embodiments described herein are not intended to be limiting and are for illustrative purposes.

### DETAILED DESCRIPTION OF PREFERRED EMBODIMENTS

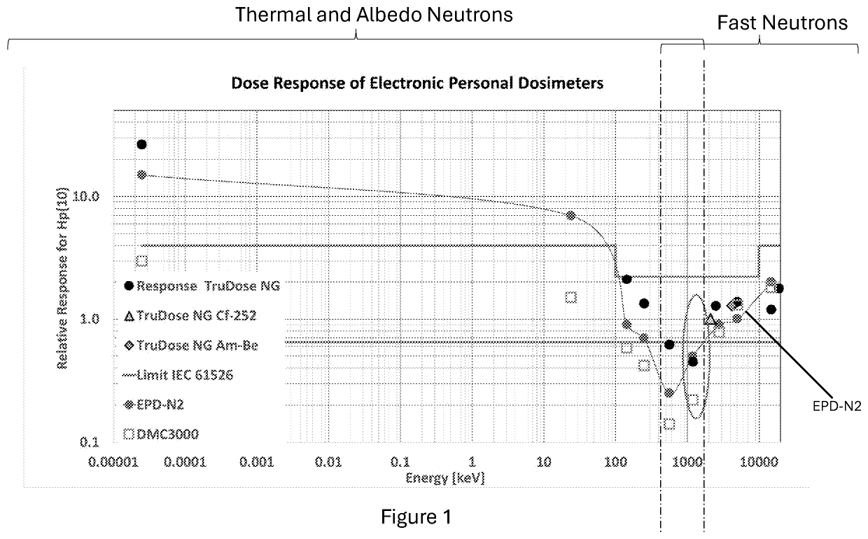

FIG. 1 is a graph showing the response of electronic personal dosimeters (EPDs) which are currently on the market to well defined neutron fields. The graph shows relative response for Hp(10) radiation with respect to energy in kiloelectron volts (keV), wherein a relative response at or near 1.0 is indicative of a highly accurate response for a given neutron energy. The graph shows the response of three different examples of EPDs, across an energy range of 0.01 electron volts (eV) to 10 megaelectron volts (MeV). Two EPDs shown on the graph are dosimeters marketed by Thermo Fisher Scientific, each of which can each detect neutron radiation: TruDose NG, which can detect neutron and gamma radiation, and EPD-N2. The graph also shows DMC 3000™. These EPDs use counting of signals to measure neutrons. Using counting, each signal received at a detector element, such as, for example, a PIN diode, within a given EPD may have a certain value, determined at least in part using one calibration factor across the range of neutron energies. EPDs may also use a combination of radiation detector elements such that each detector element is configured to be responsive to a particular form of radiation or energy range thereof. For example, conventional EPDs may employ a first diode responsive to lower energy neutrons, such as, for example, thermal neutrons, which may also be referred to herein as “albedo neutrons”, and a second diode responsive to higher energy neutrons, such as, for example, fast neutrons. Conventional methods for determining dose rates may incorporate information from different diodes to obtain individual doses and summed up thereafter to determine an overall dose.

Additionally, the graph shows the IEC 61526 revision 4 (2024) limit. As shown, none of the EPDs shown in the graph have a response which is completely within the IEC 61526 limit. For example, the response of the shown EPDs are incongruent with the IEC 61526 limit in the region of the graph bound by the vertical dashed lines, which corresponds to an energy range in which the fast neutron and thermal/albedo neutron energies overlap. In this region, the mechanisms for measuring thermal neutrons are at or near an upper bound of their designated energy range while the mechanisms for measuring fast neutrons are at or near a lower bound of their designated energy range, both of which may negatively impact the response accuracy of a given EPD. Accordingly, conventional EPDs and/or overall dose rates determined therewith may be inaccurate depending on the particular neutron population of the field in which the EPDs are employed.

The applicant has appreciated that passive dosimeters, such as TLDs or Optically Stimulated Luminescence (OSL), and their algorithms for measuring neutron radiation be tailored in advance to known applications with defined neutron radiation fields. Therefore, passive dosimeters can achieve better energy characteristics for pre-selected radiation fields with narrower energy windows. However passive dosimeters are unable to provide real-time radiation measurements and therefore are not an alternative to active dosimeters.

The applicant has appreciated that it would be advantageous to provide an alternative method for measuring neutron response, such that an active dosimeter can be provided which has a response within the IEC 61526 limit for the whole range of neutron energies. It would be advantageous to have the benefits and accuracy of a passive dosimeter whilst having a short alarm time. Such methods and corresponding apparatus will be described herein.

The new methods described herein provide a method in which information from a first diode (which may also be referred to as a first channel), is determined, and information from a second diode (which may also be referred to as a second channel) is determined.

### Method for Determining Real-Time Dose

As described in conventional methods, the information from the first and second diodes may be combined to determine a real-time dose rate (which may also be referred to herein as an alarm dose rate), wherein the real-time dose rate may be compared to a threshold. If the threshold is met, this indicates that a radiation dose is too high, and the device informs the wearer that they should leave the area. The real-time dose rate may be determined using an algorithm. The algorithm may be used to sum the dose measured at each diode from a first energy to a second energy, i.e. to sum over an energy range. In other words, the dose may be measured by integrating over an energy range to provide a real-time dose measurement.

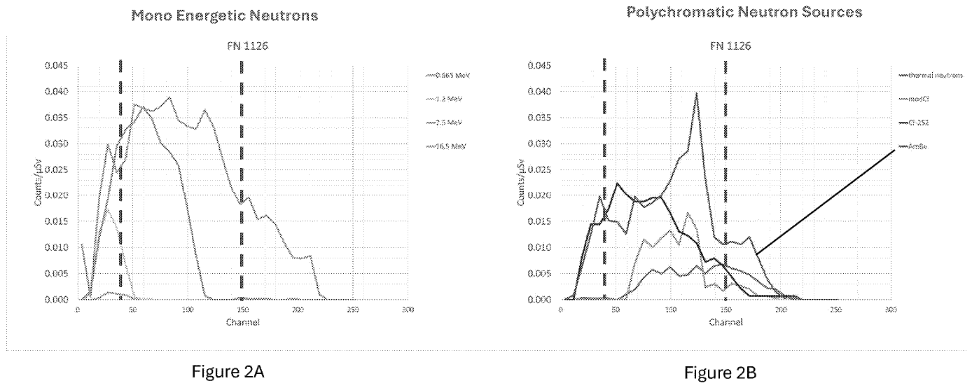

As described herein, a real-time dose rate may be calculated using fast neutron energy signals and thermal neutron energy signals, wherein the fast and thermal neutron energy responses are calculated using information received from the first and second detectors. The real-time dose rate is calculated by counting the number of neutrons received at each detector. The number of counts may be determined using a multichannel analyser (MCA) which analyses input signal consisting of voltage pulses, wherein the voltage detected at each of the thermal and fast neutron detectors is proportional to the deposited energy in the respective diode. The MCA may record the voltage pulses based on their amplitude, i.e. peak voltage, and provide an energy spectrum of number of counts vs channel energy. FIGS. 2A and 2B illustrate such an energy spectrum.

The thermal neutron counts and the fast neutron counts are each integrated between a low threshold and high threshold to provide a thermal neutron response, and a fast neutron response. The low and high thresholds are selected to provide the most accurate neutron response for each of the fast neutron spectrum and thermal neutron spectrum. The low and high thresholds are determined to reduce noise from hardware (e.g., thermal noise), noise from non-neutron radiation, and to reduce overresponse at high channels (e.g, wherein neutron energy is greater than 14 MeV).

In some examples, the low threshold may be determined such that a false neutron dose from exposure to a given radiation source is limited to a predetermined value. For example, the detector may be irradiated with Cs-137 gamma radiation at 1 Sv/h and the hardware threshold set such that the signal created by the gamma radiation is less than 100 mSv/h. Furthermore, the fast neutron and thermal neutron detectors may each be irradiated with a strongly moderated AmBe (Americium-Beryllium) source during the calibration such that there is a well-defined AmBe neutron spectrum in the fast neutron detector. This spectrum may be used to set the low and high software threshold relative to the position of the peak. FIGS. 2A and 2B show graphs of an example fast neutron signal spectrum for mono energetic neutrons (FIG. 2A), and polychromatic neutron sources (FIG. 2B). Mono energetic neutron fields may have less substructure than in polychromatic neutron sources, such as, for example, in alpha-beryllium fields. Thus, polychromatic neutron sources may provide a more reliable basis for setting thresholds. As an illustrative example of an alpha-beryllium field, a low threshold of 45 and a high threshold of 150 may be implemented for the AmBe spectrum shown. FIG. 2B shows an AmBe field in which thresholds are set such that a peak located at about channel 120 is visible.

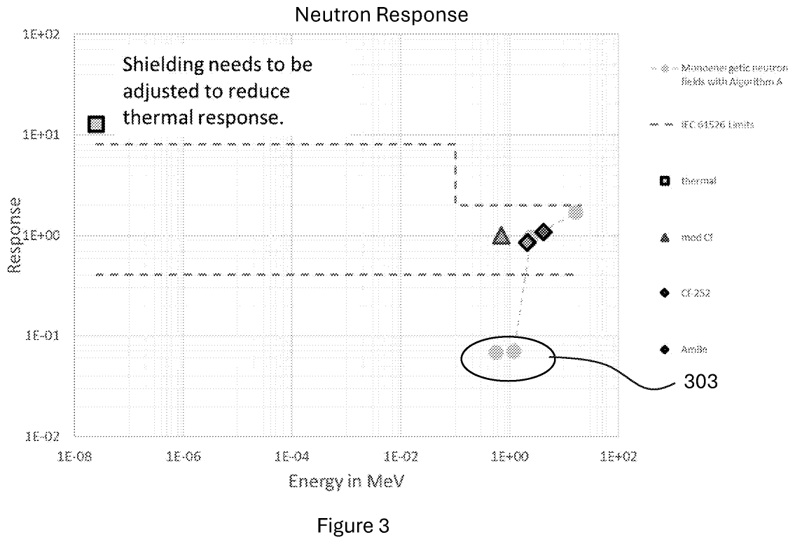

The thermal neutron detector and the fast neutron detector may each be calibrated, and the neutron responses may then be combined to give a real-time dose, as shown in FIG. 3. This may be referred to as the sum of the scalar products of weighting vectors and neutron MCA vectors. The thermal neutron response may be calibrated using a thermal neutron calibration factor, and the fast neutron response may be calibrated using a fast neutron calibration factor. These calibration factors may be predetermined, and fixed. The calibration factors may be determined using any suitable method for calibrating the fast and thermal neutron detectors. For example, the calibration factors may be calibrated with a reference source such as AmBe as described hereinabove. In one example, the real-time dose (rate) may be calculated using equation (1):

$$Hp 10 N = {CF}_{TN} \cdot ( {\sum }_{i = {L}_{TN}}^{{H}_{TN}} {TN}_{i} ) + {CF}_{FN} \cdot ( {\sum }_{i = {L}_{FN}}^{{H}_{FN}} {FN}_{i} ) \qquad ( 1 )$$

Where Hp10N is the neutron dose response, CF_{TN} is a calibration factor for the thermal neutrons, and CF_{FN} is the calibration factor for the fast neutrons. TNᵢ is the i^{th} channel of a thermal neutron multichannel analyser, FNᵢ is the i^{th} channel of a fast neutron multichannel analyser, H_{TN} and H_{FN} is high threshold of the thermal neutron channel and fast neutron channel respectively, L_{TN} and L_{FN} is low threshold of the thermal neutron channel and fast neutron channel respectively. The high and low thresholds for determining the real-time dose with the thermal and fast neutron channels may be predetermined during calibration with a reference source, for example the AmBe source, for each instrument.

Alternatively, or additionally, channels may be weighed on an individual basis to accommodate variations in neutron fields. For example, each of the channels TNᵢ and FNᵢ may be multiplied by respective channel specific calibration factors cƒ_{TN,i} and cf_{FN,i}, and the products cf_{TN,i}·TNᵢ and cf_{FN,i}·FNᵢ integrated between the low and high thresholds to provide a calibrated neutron response.

FIG. 3 shows an example of a Hp10N response based on data points, labelled 303, determined by equation (1). The points provided by equation (1) are labelled “Monoenergetic neutron fields with Algorithm A” in the graph legend. The calibration factors may depend on factors related to the configuration of the detection device used to detect the fast and thermal neutrons. In the example of FIG. 3, CF_{FN}=3.7 and CF_{TN}=1.6, wherein the calibration factors have a unit of microsieverts per count, the channel numbers are TNᵢ and FNᵢ, and the low threshold of the thermal neutrons and fast neutrons respectively are L_{TN}=50 & L_{FN}=45. The high threshold of the thermal neutrons and fast neutrons respectively are H_{TN}=150 & H_{FN}=150.

### Method for Determining Accumulated Dose

By using the first set of neutrons to calibrate the second set of neutrons, the method has the advantage that there is more information available for calculating the dose. For example, the first set of neutrons may be used to determine the energy ranges of the neutrons, and for determining calibration factors to use for the second set of neutrons. The novel techniques described herein provide an improved energy response by combining the data from the first and second detectors. In some examples, the calibration may be adjusted to accommodate variations in field populations or as the neutron spectra evolve, as the calibration may be based on the shape of the fast neutron spectrum. The method also has the advantage that the data may be used to determine a real-time or alarm dose rate, and to calculate dose over a time duration to calculate the accumulated dose over time.

In one example, the information from the first diode may be further used in combination with the information from the second diode. Therefore, the information from the fast neutrons may be used to enhance the information from the thermal neutrons. In an example, the information about the fast neutrons may be used to calibrate the radiation dose calculated by the thermal neutrons. In particular, the spectral information (i.e. the shape of the spectrum) of the fast neutrons may be used to determine a thermal neutron calibration factor for use when calibrating thermal neutrons within a certain energy range.

In one example, a shape of the spectrum, or a region thereof, for determining a thermal neutron calibration factor, or an adjustment thereof, may be determined by comparing the ratio of counts in the fast neutron channel below the lower threshold, and the counts between the low threshold and an upper threshold in the fast neutron channel. For example, based on the spectra shown in FIGS. 2A and 2B, a low threshold may be channel 45, and the upper threshold may be channel 120. Accordingly, the shape of the spectrum may be determined based on the ratio Sum (FN10-FN45)/Sum (FN45-FN120), where FNx is the x channel of the fast neutron. In this example, the sum of counts in the numerator of the ratio begins at channel 10, which was the lower cutoff of the fast neutron channels. However, it shall be understood that the lower cutoff may be changed as desired.

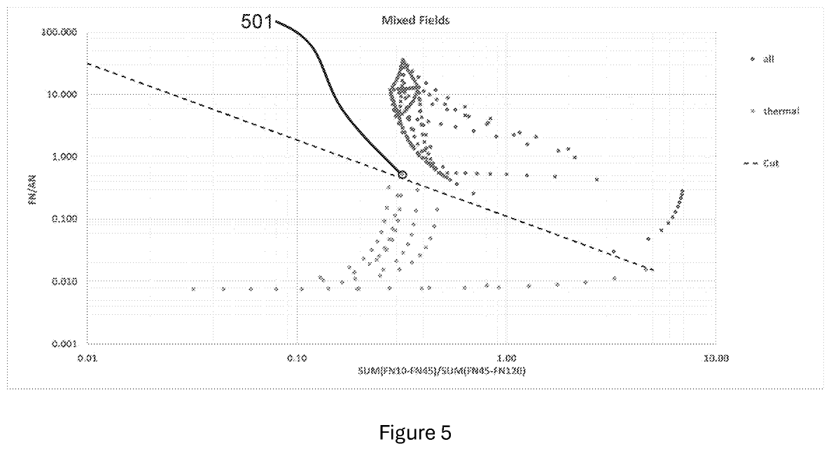

Additionally, the inventors of the present disclosure have determined that, for some fields, such as, for example, mixed-fields which may have monoenergetic neutrons and thermal neutrons, a ratio of fast neutrons to thermal neutrons (FN/AN ratio) may be used to calibrate the thermal neutrons, such that the thermal neutrons are not only calibrated using the fast neutron spectrum. For example, FIG. 5 shows a graph of measured responses for known reference field populations including mixed fields, in which the ratio of FN to AN counts is on the vertical axis, and the ratio Sum (FN10-FN45)/Sum (FN45-FN120) is on the horizontal axis. As shown by the dashed line, a geometric cut may be used to discriminate against the high thermal neutron environment. The dashed line distinguishes between neutron fields, where at least 10% of the dose comes from thermal neutrons (orange sector, below the dashed line with the exception of one point 501), and all other fields (blue sector, above the dashed line). If the calibration factor is adjusted for only the fields represented by points above the dashed line, the contribution from mixed fields with high thermal neutron contributions may be excluded.

The spectral information of the fast neutrons may also be used to estimate the energy of the neutron field so that an energy range over which to measure the radiation may be calculated. In other words, an upper energy threshold and a lower energy threshold may be calculated based on the fast neutron spectral information. The lower energy threshold is chosen such that gamma radiation is avoided. As described herein, neutron detectors may also be configured to detect gamma radiation, and therefore it has been appreciated that by setting a lower energy threshold, it is possible to avoid some or all of the detected gamma radiation being included in calculations. The upper energy threshold may be set to avoid an overresponse, as described above.

It has also been appreciated that limiting the thermal neutron detector may be more reliable when limited to certain energy regimes, and therefore by setting an upper threshold, the accuracy of the energy response may be improved. Therefore, by using the fast neutron spectrum, a range over which to a measure neutron response is calculated. The range of energies may be measured using the same method as described with relation to the real-time dose rate, described herein. In other words, a range of channels may be determined.

The neutron response for neutrons within an energy range (e.g., the energy range calculated using the fast neutron information) is calculated by combining the fast neutron and thermal neutron energy response. In the new method for determining a dose of record as described herein, the thermal neutron energy response is calculated by summing the radiation over the energy range, and calibrating the total radiation. The fast neutron energy response may be calibrated using the same fast neutron calibration factor as described in relation to the real-time dose rate. The fast neutron calibration factor may be pre-determined for all energy ranges, and is set for a certain version of personal dosimetry instrument (e.g. hardware, firmware, etc.). In other words, if the instrument changes, then the fast neutron calibration factor may change. For some neutron energies, the thermal neutron calibration factor may be pre-determined as described in relation to the real-time dose rate. For other neutron energies, the thermal neutron calibration factor may be determined using the spectral information for the fast neutrons, as described above. Therefore, the thermal neutron calibration factor may be described as an energy dependent calibration factor. The thermal neutron calibration factor may be determined based on the shape of the fast neutron spectrum.

An example of an algorithm which may be used to calculate the neutron energy response is provided by equation (2):

$$Hp 10 N = \{ \begin{matrix}\begin{matrix}{CF}_{TN} \cdot {\sum }_{i = {L}_{TN}}^{{H}_{TN}} {TN}_{i} + {CF}_{FN} \cdot {\sum }_{i = {L}_{FN}}^{{H}_{FN}} {FN}_{i} , \\ ∀ E \text{:} E \leq 0.5 MeV or E \geq 1.5 MeV\end{matrix} \\ \begin{matrix}\text{?} \cdot {\sum }_{i = {L}_{TN}}^{{H}_{TN}} {TN}_{i} + {CF}_{FN} \cdot {\sum }_{i = {L}_{FN}}^{{H}_{FN}} {FN}_{i} , \\ ∀ E \text{:} 0.5 MeV \leq E \leq 1.5 MeV\end{matrix}\end{matrix} \qquad ( 2 )$$

Where Hp10N is the neutron dose response, CF_{TN} is a first calibration factor for the thermal neutrons (wherein the first calibration factor for the thermal neutrons is used for a first energy range), CF_{FN} is the calibration factor for the fast neutrons (which is used at all energy ranges), and [symbol] is a second calibration factor for the thermal neutrons (wherein the second calibration factor for the thermal neutrons is used for a second neutron energy range). TNᵢ is the i^{th} channel of a thermal neutron multichannel analyser, FNᵢ is the i^{th} channel of a fast neutron multichannel analyser, H_{TN} and H_{FN} is high threshold of the thermal neutron channel and fast neutron channel respectively; L_{TN} and L_{FN} is low threshold of the thermal neutron channel and fast neutron channel respectively. As described herein, the thresholds may be predetermined, and the thresholds may be constant for each instrument. In other words, the same threshold values may be used in both the embodiment for the calculation of real time dose and accumulated dose.

As shown in equation 2, if the energy of the neutron field is below or equal to 0.5 MeV or above or below 1.5 MeV, a first calibration factor CF_{TN} is applied to the thermal neutron energy response. If the energy of the neutron field is greater than or equal to 0.5 MeV, and less than or equal to 1.5 MeV, a second calibration factor [symbol] is applied to the thermal neutron energy response.

The neutrons in the range of 0.5 MeV≤E≤1.5 MeV may be identified by the shape of the fast neutron spectrum, as described herein.

In some examples, the calibration factor [symbol] may be determined based on a reference spectrum or specific portion thereof. For example, based on the AmBe reference spectrum, [symbol] may have a value of 25, wherein the calibration factor is in microsievert (μSv) per count. However, it will be appreciated that this is merely an example, and the calibration factor for the thermal neutrons may change with changes in the measurement, for example different dosimeters or reference spectrum for hardware calibration.

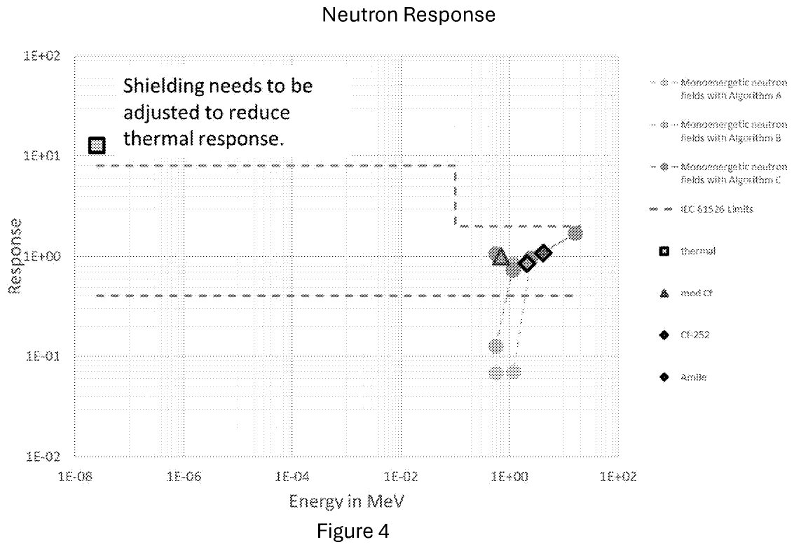

The calibrated neutron energy response calculated by equation (1) is within the IEC limit, as shown by FIG. 4. However, the calibrated neutron energy response calculated by equation (2) is calculated over a period of time, i.e. not instantaneously. It will be appreciated that to gather the required information to estimate the energy of the field, enough radiation information is needed to evaluate the shape of the spectrum. Therefore, the neutron dose information is gathered by the first and second diodes for a period of time. After a certain amount of information has been gathered, for example once information has been gathered over a predetermined period of time, the information is collated to provide the signal spectrum for both the fast and thermal neutrons as described herein.

In some examples it may be identified that the energy is 0.5 MeV≤E≤1.5 MeV if the ratio shown in equation (3) is met if:

$$\frac{{\sum }_{i = 10}^{{L}_{FN}} {FN}_{i}}{{\sum }_{i = {L}_{FN}}^{120} {FN}_{i}} > 3 \qquad ( 3 )$$

As described herein, FNᵢ is the i^{th} channel of a fast neutron multichannel analyser, L_{FN} is the low threshold of the fast neutron. It will be appreciated that the values used in the equation 3, i.e., the channels of fast neutron which are summed, are only an example, and the channels will change based on the configurations of the device.

Therefore, the method of determining a calibrated neutron response, as described herein, provides a calibrated neutron energy response which meets the IEC limits. By combining information from thermal neutrons with information from fast neutrons, the neutron response may be calibrated without requiring upfront knowledge of the radiation fields of a specific application, and without requiring high logistical effort unlike passive dosimeters.

In some examples there may be a dosimeter comprising two detectors, wherein a first detector is configured to detect fast neutrons, and a second detector is configured to detect thermal neutrons. The thermal neutron detector may use PIN diodes which may be in combination with converted materials, for example Lithium Fluoride (LiF), or Boron Carbide (B₄C), to detect thermal neutrons. The fast neutron detector may use a PIN diode which may be in combination with a proton rich and/or hydrocarbon material, such as, for example, polypropylene (PP), to detect fast neutrons. It is preferable to have both detectors located in a single instrument such that the fast neutron detector and thermal neutron detector are exposed to the same field. The present disclosure also contemplates practicing the methods described herein with other types of detectors known in the art. For example, in some implementations, the dosimeter may incorporate gas detectors for low energy neutrons and/or scintillator detectors for the high energy neutrons.

The data is processed by a processor which is in communication with the first and second detectors. The processor may be located inside the device, such that the neutron dose is calculated at the device. Alternatively, the processor may be a separate entity wherein the processor is in wired or wireless communication with the detectors. In some examples, the data is transmitted from the detectors to a dosimetry system, wherein the dosimetry system processes the data. The dosimetry system may be a web-based solution, or may be a local data base, or local server. The device comprising the two detectors may comprise a storage medium, wherein information from the two detectors is stored in the storage medium until it is provided to the processor for analysing. As discussed herein, the dose (rate) may be calculated periodically, for example monthly or quarterly. In some examples, the calculation of the dose (rate) may be triggered to record outside of the set periods, for example if a real-time dose rate has exceeded a user-defined level.

In some examples there may be a system configured to perform the methods described herein, wherein the system comprises the dosimeter (which may be the dosimeter described above), one or more MCA(s), and the system comprises a processor and a memory. Each of the plurality of MCA(s) may be configured to receive a signal from one or more of the thermal or fast neutron detectors to analyse the signals.

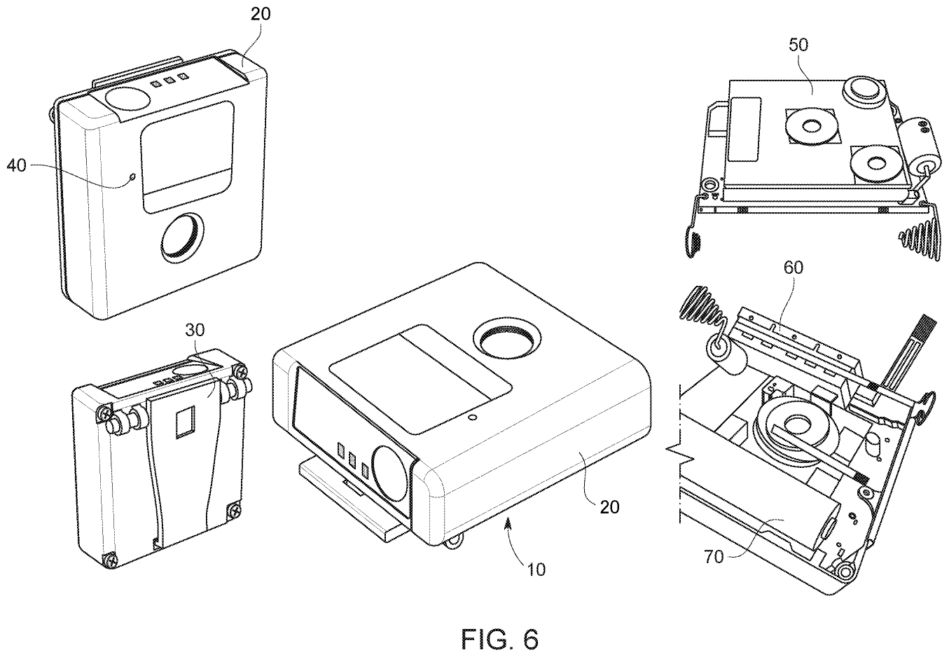

An exemplary dosimeter or radiation dose monitor (RDM) 10 is shown in FIG. 6. A housing 20 contains the components of the RDM 10, which can be attached to a person using a clip 30. A sounder or buzzer 40 may be included within the housing 20 providing alerts and other notifications. A detector board or module 50 contains a plurality of radiation detectors. A separate main or processor board 60 contains a processor used to process data generated by the radiation detectors. Other components of the RDM 10 are not shown in this figure. The RDM 10 is portable and powered by a battery 70. Other embodiments are contemplated by the present disclosure. For example, in some implementations, the components may be located on a single circuit board or multiple circuit boards and/or modules. In certain examples, the RDM may include additional components and/or configurations such as those found in U.S. Provisional Patent Application 63/781,045 entitled “RADIATION DOSE METER,” which was filed on Mar. 31, 2025 by the Applicant of the present disclosure, and which is herein incorporated by reference in its entirety, such as is described above and below. In particular, radiation captured by the detectors on the detector board 50 can be interpreted by MCA(s) to be analysed in a spectral form. Spectral processing can be accomplished by classic approaches such as template matching of Principal Component Analysis (PCA). Spectral processing can be carried out within the RDM 10 or by a separate device in communication with the RDM 10 (e.g., transferred wirelessly using BLE). Based on the information outputted, information on the type of radiation event or incident may be analysed further and displayed in a dosimetry system software user interface (accompanying software for the RDM 10). Incident indication may be accomplished using an LED alert and/or display.

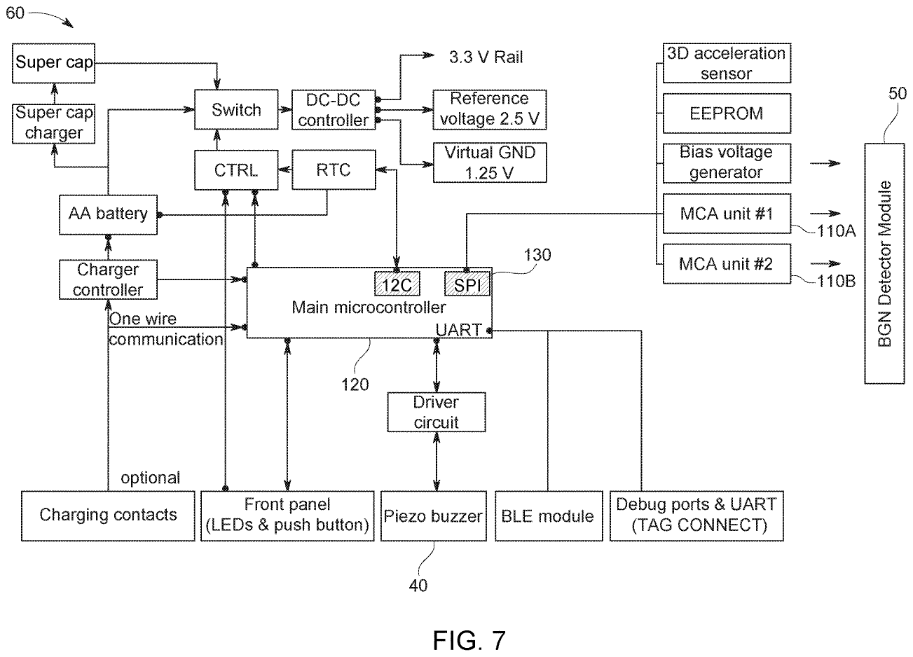

FIG. 7 is a schematic diagram of the architecture of the detector board 50 and the main board 60. The detector board 50 is not shown in detail but contains at least a first detector for detecting thermal neutrons and a second detector for detecting fast neutrons, each of which is connected to a respective multi-channel analyser (MCA) 110A, 110B to provide a signal thereto. The MCA(s) 110A, 110B digitise the data and provide the digitised data to a microcontroller or processor 120 on the main board 60 through an interface or data bus 130. Alternatively, or additionally, the digitised data may be stored in a computer readable medium for future recall and/or processing by the processor 120. The interface in this example implementation is a serial peripheral interface (SPI), although other interfaces may be used. Each MCA 110A, 110B has a plurality of channels. Signals values or pulses are placed in each channel according to criteria. For example, pulses having a particular level or intensity are placed into a corresponding channel. The main board 60 also includes memory (labelled as EEPROM) storing instructions to be executed by the processor 120.

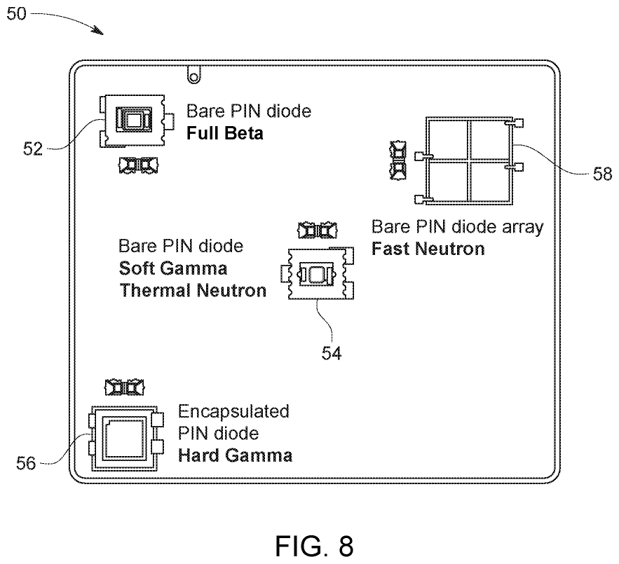

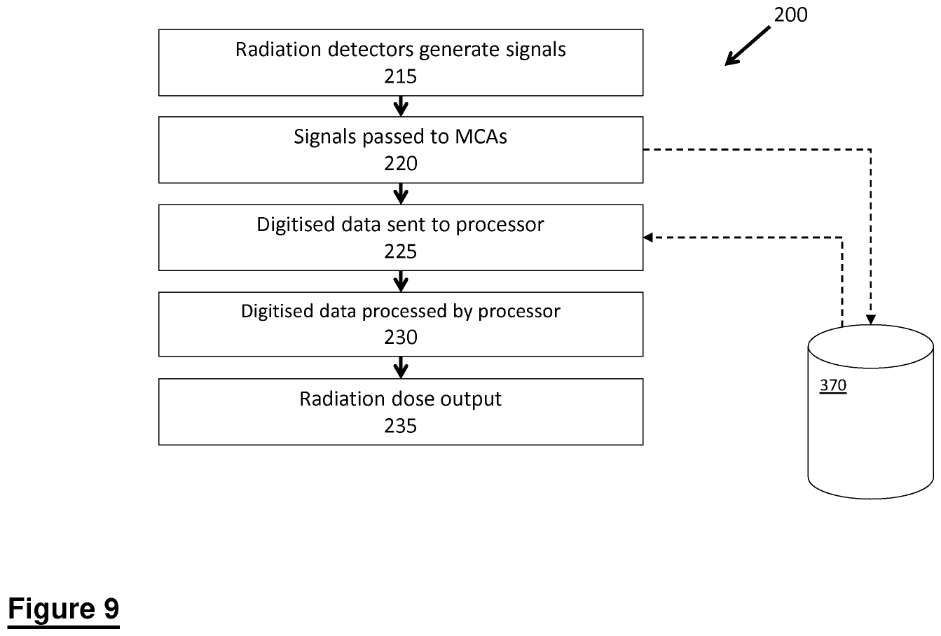

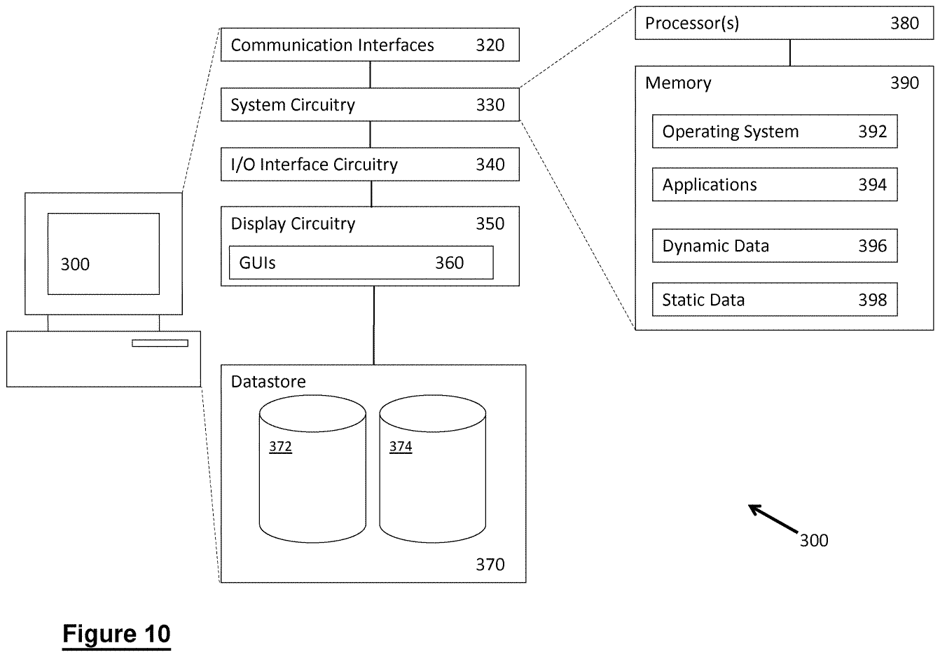

FIG. 8 shows an example layout of the detector board 50, including the plurality of radiation detectors. In this example implementation, four different detector types are shown. All four detectors in this example include PIN diodes as the sensor. Detector 52 is configured to detect beta radiation, detector 54 is configured to detect soft gamma radiation and/or thermal neutrons, detector 56 is configured to detect hard gamma radiation, and detector 58 is configured to detect fast neutrons and comprises a diode array. Detectors 52, 54 and 58 are bare PIN diodes and detector 56 is encapsulated.

FIG. 9 shows a flowchart of a method 200 for operating the RDM 10. At step 215, the radiation detector(s) generate signals due to an interaction thereof with incident radiation. The signal or signals may be generated by a single radiation detector, where only one radiation type is incident on the RDM 10, or from multiple radiation detectors if multiple sources or types of radiation are active.

At step 220, the signal or signals are passed to the MCA 110A or the MCA 110B (also referred in the singular or plural as the “MCA(s)”) in communication with the particular radiation detector generating the signal. The MCA(s) digitise the signal and passed the digitised data to the processor 120 at step 225. The processor 120 processes the digitised data at step 230 according to computer-executable instructions stored in memory for determining real-time dose and/or accumulated dose as described in elsewhere in this application, the details of which are not reproduced here for the sake of brevity. After processing, the processor 120 provides a radiation dose output or indication at step 235.

The digitised data may be stored in a datastore or database 370. As shown in FIG. 9, the digitised data may be sent directly from the MCA(s) 110A, 110B to the processor 120 or may be sent to the data store 370 and then retrieved by the processor 230. This can be particularly beneficial when data of an event is stored over time or used for historical analysis. The MCA(s) 110A, 110B may also have their own memory for storing or binning into the data channels of each MCA 110A, 110B. Alternatively, or additionally, digitised data from the MCA(s) may be retrieved and/or processed by a computer system separate from the RDM 10.

The method 200 may be implemented in a computer system 300 (FIG. 10) forming at least a portion of the RDM 10.

As shown in FIG. 10, the computer system 300 includes a number of components including communication interfaces 320, system circuitry 330, input/output (I/O) circuitry 340, display circuitry and interfaces 350, and a datastore 370. The system circuitry 320 can include one or more processors or CPUs 380 and memory 390. The system circuitry 330 may include any combination of hardware, software, firmware, and/or other circuitry. The system circuitry 330 may be implemented, with one or more systems on a chip (SoC), application specific integrated circuits (ASIC), microprocessors, and/or analogue and digital circuits.

The display circuitry may provide one or more graphical user interfaces (GUIs) 360 and the I/O interface circuitry 340 may include touch sensitive or non-touch displays, sound, voice or other recognition inputs, buttons, switches, speakers, sounders, and other user interface elements. The I/O interface circuitry 340 may include microphones, cameras, headset and microphone input/output connectors, Universal Serial Bus (USB) connectors, and SD or other memory card sockets. The I/O interface circuitry 340 may further include data media interfaces (e.g., a CD-ROM or DVD drive) and other bus and display interfaces.

The memory 390 may include volatile (RAM) or non-volatile memory (e.g., ROM or flash memory). The memory may store the operating system 392 of the computer system 300, embedded applications or software 394 (e.g., firmware), dynamic data 396, and/or static data 398. The datastore or data source 370 may include one or more databases 372, 374 and/or a file store or file system, for example. The memory 390 may be reprogrammable such that firmware stored therein can be upgraded. Accordingly, the signal analysis algorithms of the RDM 10 may be updated or tailored as needed.

A radiation event immediately causes the MCA 110A, 110B (in communication with the radiation detector sensing the event) to count pulses from its corresponding radiation detector, sort them by pulse heights into a spectrum, and/or carry out any other operations where pulse height correlates with the radiation energy. The spectrum may be used to classify the exposure type. This processing may be carried out during or after a dose accumulation above a threshold (e.g., a predetermined threshold). Alternatively, or additionally, processing may incorporate analyzing the shape of the spectrum, or a portion thereof, to identify and/or discriminate a source of radiation.

All of the aspects and/or features disclosed in this specification may be combined in any combination, except combinations where at least some of such features and/or steps are mutually exclusive. In particular, the preferred features of the disclosure are applicable to all aspects and embodiments of the disclosure and may be used in any combination. Likewise, features described in non-essential combinations may be used separately (not in combination).

As used herein, including in the claims, unless the context indicates otherwise, singular forms of the terms herein are to be construed as including the plural form and vice versa. For instance, unless the context indicates otherwise, a singular reference herein including in the claims, such as “a” or “an” means “one or more”.

Throughout the description and claims of this disclosure, the words “comprise”, “including”, “having” and “contain” and variations of the words, for example “comprising” and “comprises” or similar, mean “including but not limited to”, and are not intended to (and do not) exclude other components. Also, the use of “or” is inclusive, such that the phrase “A or B” is true when “A” is true, “B is true”, or both “A” and “B” are true.

The use of any and all examples, or exemplary language (“for instance”, “such as”, “for example” and like language) provided herein, is intended merely to better illustrate the disclosure and does not indicate a limitation on the scope of the disclosure unless otherwise claimed. No language in the specification should be construed as indicating any non-claimed element as essential to the practice of the disclosure.

The terms “first” and “second” may be reversed without changing the scope of the invention. That is, an element termed a “first” element may instead be termed a “second” element) and an element termed a “second” element may instead be considered a “first” element.

Any steps described in this specification may be performed in any order or simultaneously unless stated or the context requires otherwise. Moreover, where a step is described as being performed after a step, this does not preclude intervening steps being performed.

It is also to be understood that, for any given component or embodiment described herein, any of the possible candidates or alternatives listed for that component may generally be used individually or in combination with one another, unless implicitly or explicitly understood or stated otherwise. It will be understood that any list of such candidates or alternatives is merely illustrative, not limiting, unless implicitly or explicitly understood or stated otherwise.

In this detailed description of the various embodiments, for the purposes of explanation, numerous specific details are set forth to provide a thorough understanding of the embodiments disclosed. One skilled in the art will appreciate, however, that these various embodiments may be practiced with or without these specific details. Furthermore, one skilled in the art can readily appreciate that the specific sequences in which methods are presented and performed are illustrative and it is contemplated that the sequences can be varied and still remain within the scope of the various embodiments disclosed herein.

Unless otherwise described, all technical and scientific terms used herein have a meaning as is commonly understood by one of ordinary skill in the art to which the various embodiments described herein belongs.

It will be appreciated that embodiments of the invention may be implemented using a variety of different information processing systems. In particular, although the figures and the discussion thereof provide an exemplary computing system and methods, these are presented merely to provide a useful reference in discussing various aspects of the invention. Embodiments of the invention may be carried out on any suitable data processing device, such as a personal computer, laptop, personal digital assistant, mobile telephone, television, server computer, etc. Of course, the description of the systems and methods has been simplified for purposes of discussion, and they are just one of many different types of systems and methods that may be used for embodiments of the invention. It will be appreciated that the boundaries between logic blocks are merely illustrative and that alternative embodiments may merge logic blocks or elements, or may impose an alternate decomposition of functionality upon various logic blocks or elements.

It will be appreciated that the above-mentioned functionality may be implemented as one or more corresponding modules as hardware and/or software. For example, the above-mentioned functionality may be implemented as one or more software components for execution by a processor of the system. Alternatively, the above-mentioned functionality may be implemented as hardware, such as on one or more field-programmable-gate-arrays (FPGAs), and/or one or more application-specific-integrated-circuits (ASICs), and/or one or more digital-signal-processors (DSPs), and/or other hardware arrangements. Method steps implemented in flowcharts contained herein, or as described above, may each be implemented by corresponding respective modules;

multiple method steps implemented in flowcharts contained herein, or as described above, may be implemented together by a single module.

It will be appreciated that, insofar as embodiments of the invention are implemented by a computer program, then a storage medium and a transmission medium carrying the computer program form aspects of the invention. The computer program may have one or more program instructions, or program code, which, when executed by a computer carries out an embodiment of the invention. The term “program” as used herein, may be a sequence of instructions designed for execution on a computer system, and may include a subroutine, a function, a procedure, a module, an object method, an object implementation, an executable application, an applet, a servlet, source code, object code, a shared library, a dynamic linked library, and/or other sequences of instructions designed for execution on a computer system. The storage medium may be a magnetic disc (such as a hard drive or a floppy disc), an optical disc (such as a CD-ROM, a DVD-ROM or a BluRay disc), or a memory (such as a ROM, a RAM, EEPROM, EPROM, Flash memory or a portable/removable memory device), etc. The transmission medium may be a communications signal, a data broadcast, a communications link between two or more computers, etc.

Many combinations, modifications, or alterations to the features of the above embodiments will be readily apparent to the skilled person and are intended to form part of the invention. Any of the features described specifically relating to one embodiment or example may be used in any other embodiment by making the appropriate changes.

1. A method for determining a radiation dose, comprising:
determining information from a first set of neutrons, wherein the first set of neutrons are analysed at a first neutron detector; and
calibrating, based on the information from the first set of neutrons, a neutron signal spectrum of a second set of neutrons, wherein the second set of neutrons are analysed at a second neutron detector.

2. The method according to claim 1, wherein the method further comprises:
determining one or more calibration factors, based on the information from the first set of neutrons, wherein the calibrating step is performed using the one or more calibration factors.

3. The method according to claim 1, wherein the first set of neutrons is a set of fast neutrons, and the second set of neutrons is a set of thermal neutrons, and wherein the information is determined from a fast neutron signal spectrum.

4. The method according to claim 2, wherein the one or more calibration factors comprise a fast neutron calibration factor, and a thermal neutron calibration factor.

5. The method according to claim 4, wherein the thermal neutron calibration factor is an energy dependent calibration factor.

6. The method according to claim 4, wherein the calibrated fast neutron signal spectrum and calibrated thermal neutron signal spectrum are combined, to provide a calibrated energy response curve.

7. The method according to claim 6, further comprising determining a range of energy channels using the information, wherein the calibrated energy response curve is calculated for the range of energy channels.

8. The method according to claim 7, wherein the range of energy channels has a lower threshold and upper threshold, wherein the lower and upper thresholds are determined to reduce non-neutron radiation, and to limit the overresponse for high neutron energies.

9. The method according to claim 6, wherein the combining of the fast and thermal neutron signal spectrum is based on an energy dependent algorithm, wherein the algorithm includes the one or more calibration factors.

10. The method according to claim 7, wherein the algorithm is configured such that the calibrated energy response is within a predetermined upper limit and lower limit for the range of energy channels.

11. The method according to claim 7, wherein the calibrated energy response is calculated using the following equation:
$$Hp 10 N = \text{?} \cdot ( {\sum }_{i = {L}_{TN}}^{{H}_{TN}} {TN}_{i} ) + {CF}_{FN} \cdot ( {\sum }_{i = {L}_{FN}}^{{H}_{FN}} {FN}_{i} ) ;$$
wherein Hp10N is the energy response, [symbol] is the thermal neutron calibration factor, CF_{FN} is the fast neutron calibration factor, TNᵢ is the i^{th} channel of a thermal neutron multichannel analyser, FNᵢ is the i^{th} channel of a fast neutron multichannel analyser, H_{TN} and H_{FN} is high threshold of the thermal neutron channel and fast neutron channel, respectively, and L_{TN} and L_{FN} are low threshold of the thermal neutron channel and fast neutron channel, respectively.

12. The method of claim 1, wherein the calibrating is performed periodically over a time duration.

13. The method of claim 7, wherein calculating the calibrated energy response curve comprises integrating a thermal neutron energy response over the range of energy channels.

14. The method of claim 1, wherein the method is performed over a time duration to provide a long-term radiation dose measurement.

15. The method of claim 1, wherein the method further comprises determining an instantaneous radiation dose measurement, using information received from the first and second neutron detectors.

16. A system for determining a radiation dose, comprising:
a processor;
a first detector configured to detect a first set of neutrons; and
a second detector configured to detect a second set of neutrons, wherein the first and second detectors are configured to be in communication with a processor,
wherein the processor is configured to calibrate, based on the information about the first set of neutrons, a neutron signal spectrum of the second set of neutrons.

17. The system of claim 16, wherein the processor is further configured to determine an accumulated dose based on the calibrated neutron signal spectrum.

18. A computer-readable storage medium comprising instructions that, when executed by a processor of a system having a first detector and a second detector, cause the system to:
determine information from a first set of neutrons, wherein the first set of neutrons are analysed at the first detector; and
calibrate, based on the information from the first set of neutrons and using the processor, a neutron signal spectrum of a second set of neutrons, wherein the second set of neutrons are analysed at the second neutron detector.
